(19) United States
(12) Patent Application Publication
(10) Pub. No.: US 2008/0266455 A1
(43) Pub. Date: Oct. 30, 2008

(54) INACTIVE INFORMATION PROVIDING METHOD AND VIDEO APPARATUS THEREOF

(75) Inventors: Dong-young KIM, Seongnam-si (KR); Dae-gyu Bae, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/869,078

(22) Filed: Oct. 9, 2007

Related U.S. Application Data
(60) Provisional application No. 60/913,675, filed on Apr. 24, 2007.

(30) Foreign Application Priority Data
Jul. 4, 2007 (KR) 10-2007-0067166

(51) Int. Cl. H04N 7/015

(52) U.S. Cl. 348/552; 348/E07.004

(57) ABSTRACT

An inactive information providing method of a video apparatus includes, in an inactive mode, generating an inactive message which provides notification of the inactive mode; and transmitting the inactive message to an external device connected according to a High Definition Multimedia Interface (HDMI) Consumer Electronics Control (CEC) specification.

### CROSS-REFERENCE TO RELATED APPLICATIONS

This application claims priority from U.S. Provisional Application No. 60/913,675, filed Apr. 24, 2007, in the United States Patent and Trademark Office and claims priority from Korean Patent Application No. 10-2007-67166, filed Jul. 04, 2007, in the Korean Intellectual Property Office, the disclosures of which are incorporated herein by reference in its entirety.

### BACKGROUND OF THE INVENTION

1. Field of the Invention

Apparatuses and methods consistent with the present invention relate to inactive information and a video apparatus. More particularly, apparatuses and methods consistent with the present invention relate to providing inactive information to a connected external device, and a video apparatus.

2. Description of the Related Art

FIG. 1 depicts a video system connected according to a High Definition Multimedia Interface (HDMI) Consumer Electronics Control (CEC) specification. The video system of FIG. 1 is created by connecting a television (TV) 10 to a digital video disk recorder (DVDR) 20 using an HDMI switch 15 according to the HDMI CEC specification. Not only video signals but also control signals are transmitted and received between the TV 10 and the DVDR 20 according to the HDMI CEC specification.

Hence, the TV 10 can be connected to various video apparatuses through the HDMI switch 15.

However, when the HDMI switch 15 is in an inactive mode, the TV 10 cannot receive the video signal from the DVDR 20. If an external device other than the DVDR 20 is connected according to the HDMI CEC specification and the HDMI switch 15 enters the inactive mode, the other external device cannot be used through the TV 10.

As such, in the inactive mode of the HDMI switch 15, the video signal is not input and thus the TV 10 cannot display the normal screen. Also, the TV 10 cannot recognize the inactive mode of the HDMI switch 15.

As a result, a user needs to check whether the HDMI switch 15 is operating normally. In addition, a user who is not familiar with the video system may misunderstand the inactive mode of the HDMI switch 15 as a problem with the TV 10.

Since many diverse external devices exist, the HDMI switch is required to connect various video apparatuses. Therefore, what is needed is a method for the user to more easily connect and use the external device.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an inactive information providing method for generating and transmitting a message informing of an inactive mode of a video apparatus so as to enable a user to more easily connect and use an external device, and the video apparatus thereof.

The present invention provides an inactive information providing method for acquiring a message informing of an inactive mode of a connected external device from the external device, and a video apparatus thereof.

According to an aspect of the present invention, an inactive information providing method comprises, in an inactive mode of a device, generating an inactive message which provides notification of the inactive mode; and transmitting the inactive message to an external device connected according to an HDMI CEC specification.

The inactive message may comprise an inactive command code.

The inactive message may further comprise inactive reason information which indicates a cause of the inactive mode.

The inactive reason information may comprise power-off information, standby information, power save mode information, and sleep mode information.

The transmitting operation may broadcast the inactive message.

The inactive message may comprise an inactive command code, and a destination address in a header block of the inactive message may be assigned a destination address of the broadcasting.

According to the aspect of the present invention, a video apparatus comprises a controller which, in an inactive mode, generates an inactive message which provides notification of the inactive mode; and an interface which transmits the inactive message to an external device connected according to an HDMI CEC specification.

The inactive message may comprise an inactive command code.

The inactive message may further comprise inactive reason information which indicates a cause of the inactive mode.

The inactive reason information may comprise power-off information, standby information, power save mode information, and sleep mode information.

The interface may broadcast the inactive message.

The inactive message may comprise an inactive command code, and a destination address in a header block of the inactive message may be assigned a destination address of the broadcasting.

According to another aspect of the present invention, an inactive information providing method comprises connecting an external device according to an HDMI CEC specification; and receiving an inactive message informing of an inactive mode of the external device, from the external device.

The inactive information providing method may further comprise selecting another input signal when the inactive message is received.

The inactive information providing method may further comprise stopping a current service when the inactive message is received.

The inactive message may comprise an inactive command and inactive reason information which indicates a cause of the inactive mode.

According to the another aspect of the present invention, a video apparatus comprises an interface which receives an inactive message which provides notification that an external device connected according to an HDMI CEC specification is inactive; and a controller which determines whether the external device is inactive or not based on the received inactive message.

The controller may select another input signal when the inactive message is received through the interface.

The controller may stop a current service when the inactive message is received through the interface.

The inactive message may comprise an inactive command and inactive reason information which indicates a cause of the inactive mode.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a diagram of a video system according to an HDMI CEC specification;

FIG. 2 is a block diagram of a video system to which exemplary embodiments of the present invention are applicable;

FIG. 3 is a flowchart of an inactive information providing method according to an exemplary embodiment of the present invention;

FIG. 4 is a diagram of a message structure according to the HDMI CEC specification according to an exemplary embodiment of the present invention;

FIG. 5 is a diagram of an inactive message structure according to an exemplary embodiment of the present invention;

FIG. 6 is a table of inactive reason information according to an exemplary embodiment of the present invention;

FIG. 7 is a block diagram of a video apparatus according to another exemplary embodiment of the present invention;

FIG. 8 is a flowchart of an inactive information providing method according to another exemplary embodiment of the present invention;

FIG. 9 is a block diagram of a video apparatus according to a further exemplary embodiment of the present invention; and

FIG. 10 is a flowchart of an inactive information providing method according to a further exemplary embodiment of the present invention.

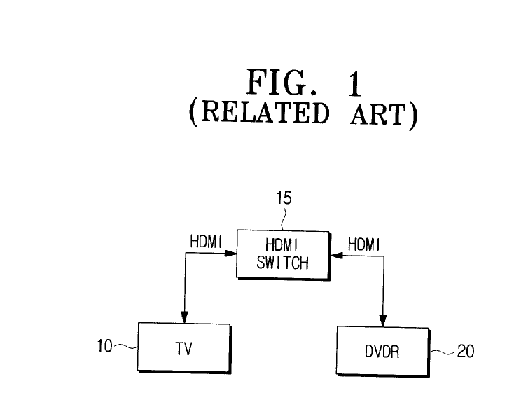

### DETAILED DESCRIPTION OF EXEMPLARY EMBODIMENTS

Certain exemplary embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the present invention can be carried out without those specifically defined matters. Also, well-known functions or constructions are not described in detail since they would obscure the invention with unnecessary detail.

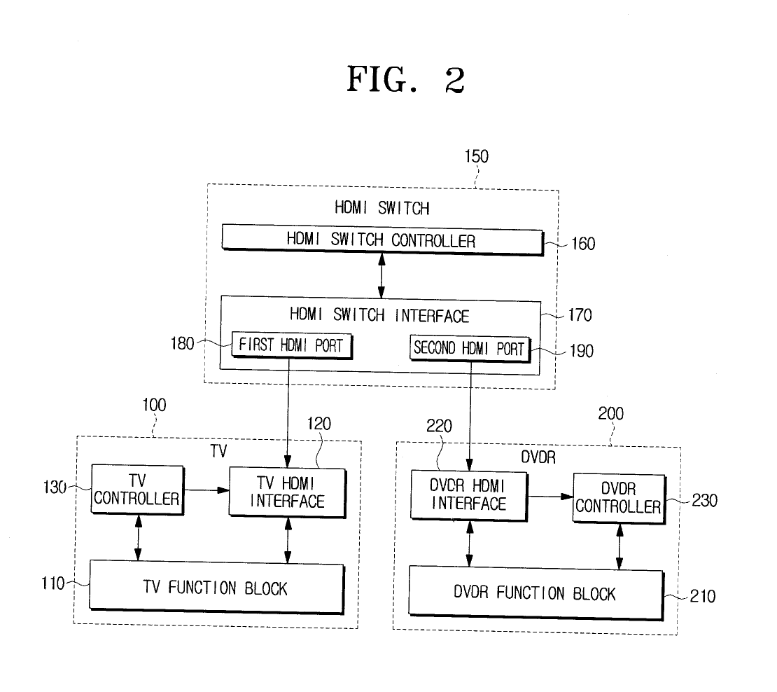

FIG. 2 is a block diagram of a video system to which the present invention is applicable. The video system of FIG. 2 is constituted by connecting a TV 100 to a digital versatile disk recorder (DVDR) 200 using an HDMI switch 150 according to an HDMI CEC specification.

The HDMI switch 150 comprises a plurality of HDMI ports. Using the HDMI switch 150, a user can connect diverse video apparatuses, for example, but not limited to, DVDR, game console, computer, home theatre, and so forth, to a single display device. The HDMI switch 150 can provide a function for selecting an active video apparatus which is to be displayed on the display device among the connected video apparatuses.

As shown in FIG. 2, the TV 100 comprises a TV function block 110, a TV HDMI interface 120, and a TV controller 130.

The TV function block 110 performs the TV proper function. The TV function block 110 decodes and scales a broadcast signal received from a broadcasting station by cable or by radio and displays the processed broadcast signal so that the user can view the broadcast screen. The TV function block 110 can display a video corresponding to a video signal received from the DVDR 200 through the TV HDMI interface 120 on a display, which is to be explained.

The TV HDMI interface 120 is connected to the DVDR 200 through the HDMI switch 150 according to the HDMI CEC specification to transmit and receive messages of mutual control function between the TV 100 and the DVDR 200.

The TV HDMI interface 120 can receive an inactive message providing notification of the inactive mode from the HDMI switch 150.

The TV controller 130 controls the operation of the TV function block 110 according to a user command or a received message. The TV controller 130 can control the DVDR 200 by sending a control command to the DVDR 200 through the TV HDMI interface 120.

When receiving an inactive message from the HDMI switch 150, the TV controller 130 controls the TV HDMI interface 120 to select another input signal or controls the TV function block 110 to stop the current service.

For example, when the HDMI switch 150 is turned off, the TV 100 receives an inactive message from the HDMI switch 150. The TV controller 130 can control the TV HDMI interface 120 to select an input signal of another video apparatus through another switch. The TV controller 130 can also control the TV function block 110 to display its received broadcast video on a screen.

Since the video signal of the currently reproduced video is not input any more, the TV controller 130 can control the TV function block 110 to abort the current video replay service. In doing so, the TV controller 130 may control the TV function block 110 to display a message providing notification of the inactive mode of the HDMI switch 150 onto the screen.

The HDMI switch 150 of FIG. 2 comprises an HDMI switch controller 160, an HDMI switch interface 170, a first HDMI port 180, and a second HDMI port 190.

The HDMI switch controller 160 controls overall operation of the HDMI switch 150. The HDMI switch controller 160 checks the connection state of the HDMI ports 180 and 190, checks the input and output state of the connected ports, and distributes the load of the ports.

When the HDMI switch 150 becomes inactive, the HDMI switch controller 160 generates an inactive message providing notification of the inactive mode of the HDMI switch 150. The inactive message comprises an inactive command code, and inactive reason information indicative of the cause of the inactive mode. Herein, the inactive reason information comprises power-off information, standby information, power save mode information, and sleep mode information.

The HDMI switch controller 160 can control the broadcast of the inactive message to the external device by inputting a broadcast address value in a destination address of a header block of the inactive message, which is to be explained by referring to FIG. 5.

The HDMI switch interface 170 comprises the first HDMI port 180 and the second HDMI port 190. Note that the HDMI switch interface 170 can comprise a greater number of HDMI ports. By means of the HDMI ports, the HDMI switch interface 170 connects various video apparatuses to the HDMI switch 150 and enables the mutual communications.

The HDMI switch interface 170 broadcasts the inactive message generated at the HDMI switch controller 160 to all external devices. For example, when the HDMI switch 150 is turned off, the inactive message generated at the HDMI switch 150 is received at the TV 100 and the DVDR 200 through the HDMI switch interface 170.

The DVDR 200 of FIG. 2 comprises a DVDR function block 210, a DVDR HDMI interface 220, and a DVDR controller 230.

The DVDR function block 210 performs proper functions of the DVDR 200. The DVDR function block 210 records the broadcast signal input from the TV 100 through the DVDR HDMI interface 200, to be explained, to a mounted DVD, or reads a video signal from the mounted DVD and provides the read video signal to the TV 100 through the DVDR HDMI interface 220.

The DVDR HDMI interface 220 is connected to the TV 100 through the HDMI switch 150 according to the HDMI CEC specification to transmit and receive video signals and messages between the TV 100 and the DVDR 200. The DVDR HDMI interface 220 receives the inactive message from the HDMI switch 150.

The DVDR controller 230 controls the operation of the DVDR function block 210 according to the control command of the TV 100 which is input through the HDMI switch 150.

The DVDR controller 230 controls the operation of the DVDR function block 210 according to the inactive message fed from the HDMI switch 150. For example, when the HDMI switch 150 is turned off, the DVDR 200 receives the inactive message from the HDMI switch 150. The DVDR controller 230 can control the DVDR function block 210 to stop the DVDR replay.

So far, the structure of the video system according to an exemplary embodiment of the present invention has been described by referring to FIG. 2.

While the HDMI switch 150 has been described as a separate device for the understanding of the exemplary embodiment of the present invention, the HDMI switch 150 may not be a separate device. For example, a module which functions as the HDMI switch may be embedded in a TV or a computer.

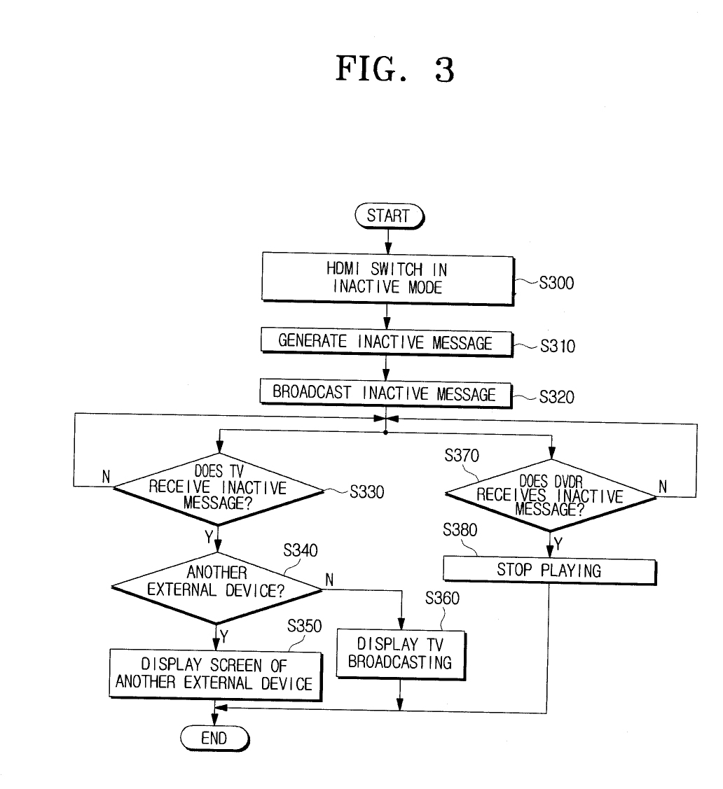

Now, the broadcast procedure of the inactive message by the HDMI switch 150 and the operations of the TV 100 and the DVDR 200 which receive the inactive message are described in detail by referring to FIG. 3.

As shown in FIG. 3, the HDMI switch controller 160 determines whether the HDMI switch 150 is inactive (S300). The inactive mode indicates various states when the HDMI switch 150 cannot function as the switch. For example, the inactive mode corresponds to the power-off, the standby mode, the power save mode, and the sleep mode of the switch.

When the HDMI switch 150 is in the inactive mode, the HDMI switch controller 160 generates an inactive message (S310). The inactive message comprises an inactive command code, and inactive reason information indicative of the inactive cause. The inactive reason information comprises power-off information, standby information, power save mode information, and sleep mode information.

Next, the HDMI switch 150 broadcasts the inactive message (S320). The broadcast inactive message is received at the TV 100 and the DVDR 200.

Upon receiving the inactive message (S330-Y), the TV 100 cannot receive the video through the HDMI switch 150 any more. Thus, the TV 100 determines whether there exists another external device (S340).

When there is another external device connected to the TV 100 (S340-Y), the TV 100 receives a video signal from the another external device and displays the received video signal on the screen (S350). By contrast, when there is no another external device connected to the TV 100 (S340-N), the TV 100 displays its received broadcast video on the screen (S360).

Upon receiving the inactive message (S370-Y), the DVDR 200 cannot display the video of the reproduced DVD on the TV 100. Thus, the DVDR 200 stops the DVD play (S380).

So far, the inactive information providing method of FIG. 3 has been illustrated in detail.

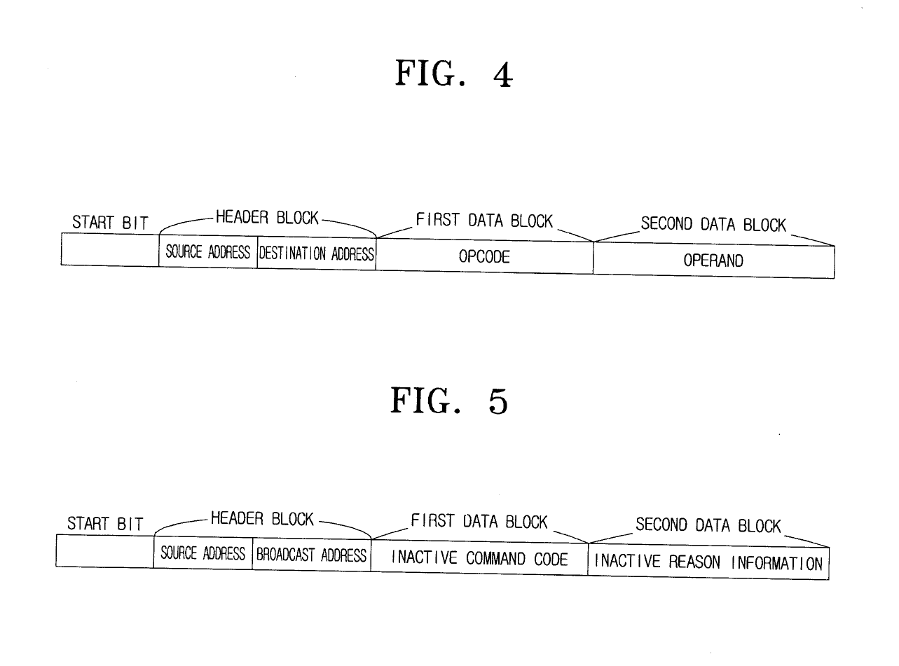

The message structure is now explained in detail by referring to FIGS. 4, 5 and 6. FIG. 4 shows a message structure according to the HDMI CEC specification according to an exemplary embodiment of the present invention.

As shown in FIG. 4, the message based on the HDMI CEC specification comprises a start bit, a header block, a first data block, and a second data block.

The start bit indicates the start of the message. In general, a 1-bit start bit is most preferable. However, the start bit is not limited to 1 bit and may comprise several bits.

The header block comprises a source address and a destination address. The source address is a message transmitting address and the destination address is a message receiving address. The source address and the destination address may be in a logical address form.

The header block further comprises an End Of Message (EOM) bit (not shown) and an Acknowledge (ACK) bit (not shown). The EOM bit indicates the end of the message. For example, the EOM bit ‘0’ indicates no end of the message and ‘1’ indicates the end of the message. When the message comprises the EOM bit, the end of the message can be detected. Hence, the message can be of a variable length.

The ACK bit indicates whether the message is successfully received at the destination. For example, when the message is initially generated, the ACK bit is set to ‘1’. When the message is transferred to the device of the wrong destination address, the device responds with the ACK bit ‘1’. When the message is received at the destination device, the device responds with the altered ACK bit ‘0’. The source device checks whether the message was successfully transmitted by examining whether the ACK bit of the response message is ‘0’ or ‘1’.

In general, the source address and the destination address of the HDMI CEC each comprise 4 bits, and the EOM bit and the ACK bit each comprise 1 bit. Accordingly, the header block comprises 10 bits in total.

The first data block comprises OPCODE which is a command code value corresponding to the message role. That is, the OPCODE carries the code value of the command code. For example, the command <Active Source> for delivering the active source address has the OPCODE value of 0×82.

The OPCODE is the 8-bit code value. The first data block also comprises an EOM bit and an ACK bit. Hence, the first data block comprises 10 bits in total.

The second data block comprises OPERAND which is a parameter value of the command corresponding to the OPCODE. Accordingly, the OPERAND value is determined by the OPCODE. For example, the command <Active Source> accompanies the parameter value [Physical Address]. Hence, the OPERAND contains [Physical Address] information.

The OPERAND comprises a plurality of data blocks. Each block comprises 8-bit data, an EOM bit, and an ACK bit, and thus comprises 10 bits in total. The HDMI CEC specification describes that the OPERAND can comprise a maximum of 14 data blocks. In other words, the second data block can comprise a maximum of 14 data blocks, therefore its maximum size is 140 bits (=14*10).

As above, the message comprises the header block, the first data block, and the second data block, and its total size is 160 bits (=16*10).

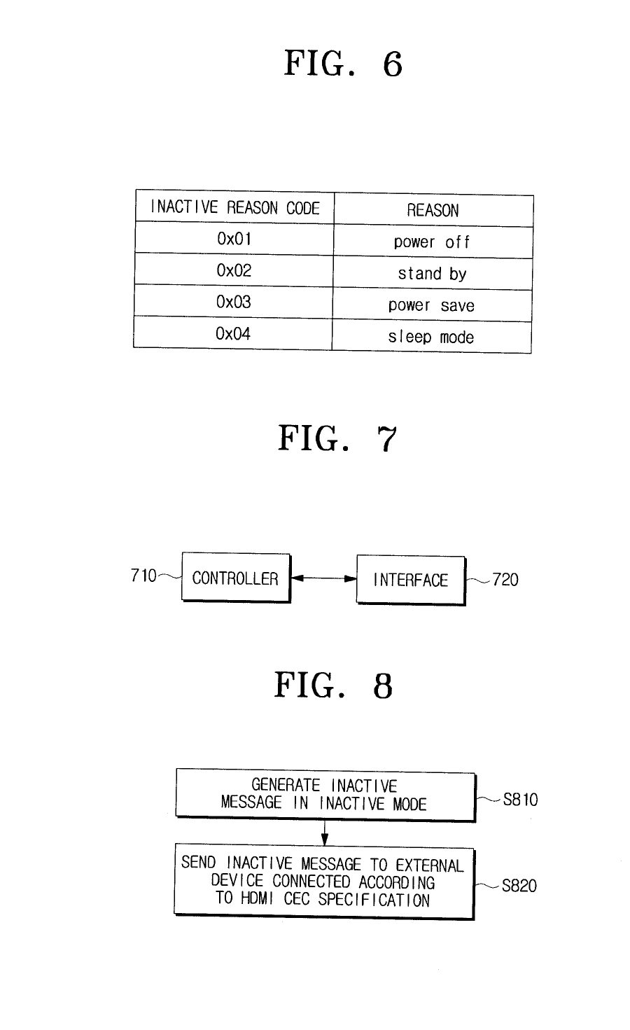

FIG. 5 shows an inactive message structure according to an exemplary embodiment of the present invention. FIG. 6 is a table of the inactive reason information according to an exemplary embodiment of the present invention.

The inactive message of FIG. 5 comprises a start bit, a header block, a first data block, and a second data block.

The header block comprises a source address and a destination address. Since the HDMI switch 150 broadcasts the inactive message, the source address is a logical address value of the HDMI switch 150 and the destination address is a logical address value indicative of the broadcasting.

The first data block comprises an inactive command code recorded as OPCODE. For example, the inactive command code can be defined as <Inactive Route>.

The second data block comprises inactive reason information which specifies the cause of the inactive mode. The inactive reason information may be carried in the second data block by allocating a code value by cases.

The inactive reason code can be designated as shown in FIG. 6. The inactive reason code assigns 0×01 to the power-off, 0×02 to the standby, 0×03 to the power save, and 0×04 to the sleep mode. For example, when the HDMI switch 150 is turned off and thus enters the inactive mode, the inactive message <Inactive Route> (0×01) is broadcast.

While the exemplary inactive mode comprises the four cases in FIG. 6, various additional inactive causes may be possible. While the exemplary inactive reason code is represented as the hexadecimal code, it can be expressed in other code forms.

So far, the message structure has been illustrated based on FIGS. 4, 5 and 6.

In the exemplary embodiment of the present invention, the message is constructed as described in the HDMI CEC specification by way of example. Note that the message can be constructed according to other specification or as freely defined by the manufacturer.

Thus, the structure and the size of the message may vary from the message of the exemplary embodiment of the present invention.

While the video system comprises the TV 100 and the DVDR 200 in the exemplary embodiment of the present invention, the present invention is applicable to a video system including other video apparatuses. The video apparatuses for constituting the video system can comprise, for example, but not limited to, TV, DVDR, set-top box (STB), DVD player (DVDP), digital video recorder (DVR), personal video recorder (PVR), hard disk drive (HDD) player, blue-ray disk (BD) player, BD recorder, video cassette recorder (VCR), home theatre system, personal multimedia player (PMP), digital camera, digital camcorder.

While the HDMI switch 150 is provided as the separate device for the understanding of the present invention, it can be implemented as a module within the video apparatus.

The video apparatuses for constituting the video system are connected according to the HDMI CEC specification to ease the understanding of the present invention. Besides the HDMI CEC specification, the present invention is applicable to any scheme for transceiving the video signals and messages between the video apparatuses.

In the following, other embodiments of the present invention are described in detail by referring to FIGS. 7 through 10.

FIG. 7 is a block diagram of a video apparatus according to another exemplary embodiment of the present invention. For the inactive mode, a controller 710 of FIG. 7 generates an inactive message providing notification of the inactive mode. An interface 720 transmits the inactive message to an external device connected according to the HDMI CEC specification.

FIG. 8 is a flowchart of an inactive information providing method according to another exemplary embodiment of the present invention. In the inactive mode, the video apparatus generates the inactive message providing notification of the inactive mode (S810). Next, the video apparatus transmits the inactive message to the external device connected according to the HDMI CEC specification (S820).

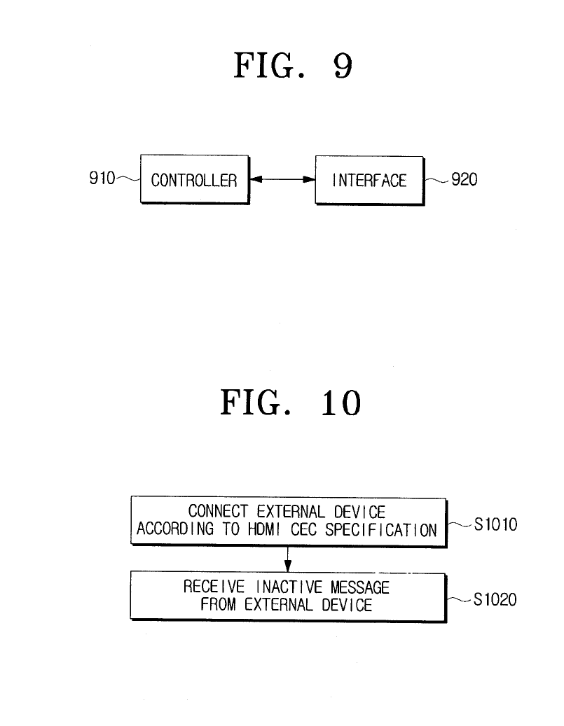

FIG. 9 is a block diagram of a video apparatus according to a further embodiment of the present invention. An interface 920 receives an inactive message providing notification that an external device connected according to the HDMI ECE specification becomes inactive. A controller 910 determines whether the external device is in the inactive mode based on the received inactive message.

FIG. 10 is a flowchart of an inactive information providing method according to a further embodiment of the present invention. The video apparatus connects an external device according to the HDMI CEC specification (S1010). Next, the video apparatus receives the inactive message providing notification that the external device connected according to the HDMI CEC specification is in the inactive mode (S1020).

Therefore, the video apparatus can transmit the inactive message to the connected external device.

As set forth above, the inactive information providing method for generating and transmitting the message providing notification of the inactive mode of the video apparatus and the video apparatus thereof enable the user to more easily connect and use the external device.

Since the connected external devices are notified of the inactive mode of the HDMI switch, they can properly cope with the inactive mode of the HDMI switch. Accordingly, the user can easily determine the trouble with the HDMI switch.

Furthermore, the inactive message, which is not defined in the HDMI CEC specification, allows the compatibility of the video apparatus.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. An inactive information providing method comprising:
generating an inactive message which informs of an inactive mode of a device; and
transmitting the inactive message to an external device connected according to a High Definition Multimedia Interface (HDMI) Consumer Electronics Control (CEC) specification.

2. The inactive information providing method of claim 1, wherein the inactive message comprises an inactive command code.

3. The inactive information providing method of claim 2, wherein the inactive message further comprises inactive reason information which indicates a cause of the inactive mode.

4. The inactive information providing method of claim 3, wherein the inactive reason information comprises at least one of power-off information, standby information, power save mode information, and sleep mode information.

5. The inactive information providing method of claim 1, wherein the transmitting the inactive message further comprises broadcasting the inactive message.

6. The inactive information providing method of claim 5, wherein the inactive message comprises an inactive command code, and a destination address in a header block of the inactive message is assigned a destination address of the broadcasting.

7. A video apparatus comprising:
a controller which, in an inactive mode, generates an inactive message which provides notification of the inactive mode; and
an interface which transmits the inactive message to an external device connected according to a High Definition Multimedia Interface (HDMI) Consumer Electronics Control (CEC) specification.

8. The video apparatus of claim 7, wherein the inactive message comprises an inactive command code.

9. The video apparatus of claim 8, wherein the inactive message further comprises inactive reason information which indicates a cause of the inactive mode.

10. The video apparatus of claim 9, wherein the inactive reason information comprises at least one of power-off information, standby information, power save mode information, and sleep mode information.

11. The video apparatus of claim 7, wherein the interface broadcasts the inactive message.

12. The video apparatus of claim 11, wherein the inactive message comprises an inactive command code, and a destination address in a header block of the inactive message is assigned a destination address of the broadcasting.

13. An inactive information providing method comprising:
connecting an external device according to a High Definition Multimedia Interface (HDMI) Consumer Electronics Control (CEC) specification; and
receiving an inactive message providing notification of an inactive mode of the external device, from the external device.

14. The inactive information providing method of claim 13, further comprising:
selecting another input signal when the inactive message is received.

15. The inactive information providing method of claim 13, further comprising:
stopping a current service when the inactive message is received.

16. The inactive information providing method of claim 13, wherein the inactive message comprises an inactive command and inactive reason information which indicates a cause of the inactive mode.

17. A video apparatus comprising:
an interface which receives an inactive message which provides notification that an external device connected according to a High Definition Multimedia Interface (HDMI) Consumer Electronics Control (CEC) specification is inactive; and
a controller which determines whether the external device is inactive or not based on the received inactive message.

18. The video apparatus of claim 17, wherein the controller selects another input signal when the inactive message is received through the interface.

19. The video apparatus of claim 17, wherein the controller stops a current service when the inactive message is received through the interface.

20. The video apparatus of claim 17, wherein the inactive message comprises an inactive command and inactive reason information which indicates a cause of the inactive mode.
